(19) United States
(12) Patent Application Publication
(10) Pub. No.: US 2026/0296115 A1
(43) Pub. Date: Oct. 1, 2026

(54) TRAILER HITCH TUBE MOUNTED ACCESSORIES AND VEHICLES INCLUDING TRAILER HITCH MOUNTED ACCESSORIES

(71) Applicant: Toyota Motor Engineering & Manufacturing North America, Inc., Plano, TX (US)

(72) Inventors: Aaron R. Steinhilb, Milan, MI (US); Timothy J. Woychowski, Howell, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/090,668

(22) Filed: Mar. 26, 2025

(51) Int. Cl. B60D 1/56; B60D 1/00

(52) U.S. Cl. CPC B60D 1/56; B60D 2001/001

(57) ABSTRACT

A trailer hitch tube mounted vehicle accessory includes a connector assembly comprising a pair of opposing wedge members having angled faces that face each other and a fastener that connects the wedge members together such that torqueing the fastener pulls the wedge members together causing the wedge members to slide laterally in opposite directions thereby engaging opposing interior surfaces of a trailer hitch tube.

### TECHNICAL FIELD

The present specification generally relates to trailer hitch tube mounted accessories and methods of mounting accessories using trailer hitch tubes.

### BACKGROUND

Off-roading is a common activity where vehicles, such as trucks and jeeps, are driven over rough terrain. Such activity can subject the vehicles to damage, particularly plastic vehicle parts that are contacted easily due to approach and departure angles of the vehicle. Accordingly, what is needed are protective reinforcements for reducing damage to the vehicles during off-roading.

### SUMMARY

In accordance with one embodiment, a trailer hitch tube mounted vehicle accessory includes a connector assembly comprising a pair of opposing wedge members having angled faces that face each other and a fastener that connects the wedge members together such that torqueing the fastener pulls the wedge members together causing the wedge members to slide laterally in opposite directions thereby engaging opposing interior surfaces of a trailer hitch tube.

In accordance with another embodiment, a vehicle includes . . . a trailer hitch tube and a trailer hitch tube mounted vehicle accessory comprising a connector assembly mounted within the trailer hitch tube, the connector assembly comprising a pair of opposing wedge members having angled faces that face each other and a fastener that connects the wedge members together such that torqueing the fastener pulls the wedge members together causing the wedge members to slide laterally in opposite directions thereby engaging opposing interior surfaces of the trailer hitch tube.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following description of the illustrative embodiments can be understood when read in conjunction with the following drawings, where like structure is indicated with like reference numerals and in which:

FIG. 1 schematically depicts a rear view of a pickup truck, according to one or more embodiments shown and described herein;

FIG. 2 schematically depicts a rear portion of a pickup truck with a bumper slider, according to one or more embodiment shown and described herein;

FIG. 3 schematically depicts a trailer hitch tube, according to one or more embodiments shown and described herein;

FIG. 4 schematically depicts a connector assembly of the bumper slider of FIG. 2 inside the trailer hitch tube of FIG. 3 in an initial configuration, according to one or more embodiments shown and described herein; and

FIG. 5 schematically depicts the connector assembly of FIG. 4 in an engaged configuration, according to one or more embodiments shown and described herein.

### DETAILED DESCRIPTION

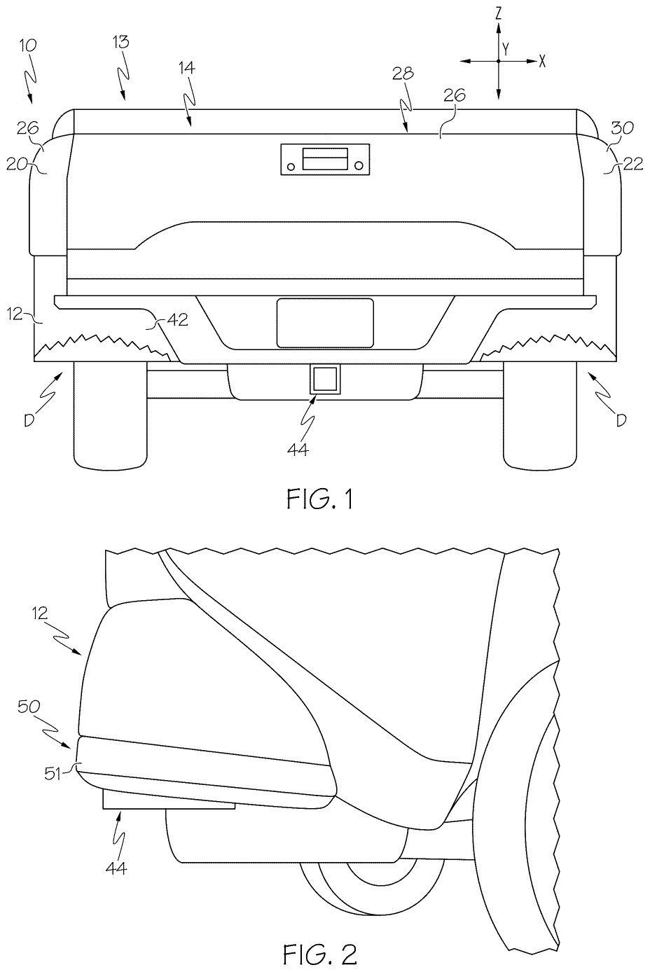

Pickup trucks according to the present specification are vehicles that include a passenger cabin and a truck bed located rearward of the passenger cabin. Often located below the truck beds are trailer hitch tubes that are configured to receive trailer hitches. A trailer hitch tube mounted vehicle accessory, such as a bumper slider, can be used to limit damage to the trucks due to off-roading. FIG. 1 shows an example of a truck 10 with damage D to bumper 12. The bumper slider includes a connector assembly comprising a pair of opposing wedge members having angled faces that face each other and a fastener that connects the wedge members together such that torqueing the fastener pulls the wedge members together causing the wedge members to slide laterally in opposite directions thereby engaging opposing interior surfaces of the trailer hitch tube.

As used herein, the term “vehicle longitudinal direction” refers to the forward-rearward direction of the pickup truck (i.e., in the vehicle Y direction depicted in FIG. 1). The term “vehicle lateral direction” refers to the cross-pickup truck direction (i.e., in the vehicle X direction depicted in FIG. 1), and is transverse to the vehicle longitudinal direction. The term “vehicle vertical direction” refers to the upward-downward direction of the pickup truck (i.e., in the vehicle Z-direction depicted in FIG. 1). As used herein, “upper,” “over” and “above” are defined as the positive Z direction of the coordinate axis shown in the drawings. “Lower,” “under,” and “below” are defined as the negative Z direction of the coordinate axis shown in the drawings.

Referring to FIG. 1, the terms “outboard” or “outward” as used herein refers to the relative location of a component in a direction with respect to a pickup truck centerline. The term “inboard” or “inward” as used herein refers to the relative location of a component in a direction with respect to the pickup truck centerline. Because the pickup truck structures may be generally symmetrical about the pickup truck centerline, the direction to which use of terms “inboard,” “inward,” “outboard” and “outward” refer may be mirrored about the pickup truck centerline when evaluating components positioned along opposite sides of the pickup truck 10.

The pickup truck 10 includes a passenger cabin 13 and a truck bed 14. The truck bed 14 includes a bed deck (i.e., a floor), a pair of spaced apart sidewalls 20, 22, a front wall and a rear wall 26. The floor, the sidewalls 20, 22, the front wall, and the rear wall 26 define a storage area 28 of the truck bed 14.

The sidewalls 20, 22 extend parallel to the vehicle longitudinal direction. Each sidewall 20, 22 includes a front end and an opposite rear end 30 that forms a rear pillar of the truck bed 14. The rear wall 26 extends between the rear ends 34, 36 of the sidewalls 20, 22.

In some embodiments, it is appreciated, that the rear wall 26 is pivotally connected to the sidewalls 20, 22 as a tailgate for movement between a closed position and an open position. In the closed position, the rear wall 26 extends parallel to the vehicle vertical direction. In the open position, the rear wall 26 extends parallel to the vehicle longitudinal direction.

Below the tailgate 26 is the rear bumper 12. The rear bumper 12 may include a reinforcement that is covered in one or more bumper panels 42. A trailer hitch tube 44 may be located beneath the rear bumper 12 and connected to a frame of the truck 10. In some cases, one or more of the bumper panels 42 may be formed of plastic or a softer metal material. In this regard, the bumper panels 42, particularly at lower areas of the rear bumper 12 may become damaged during off-roading activity.

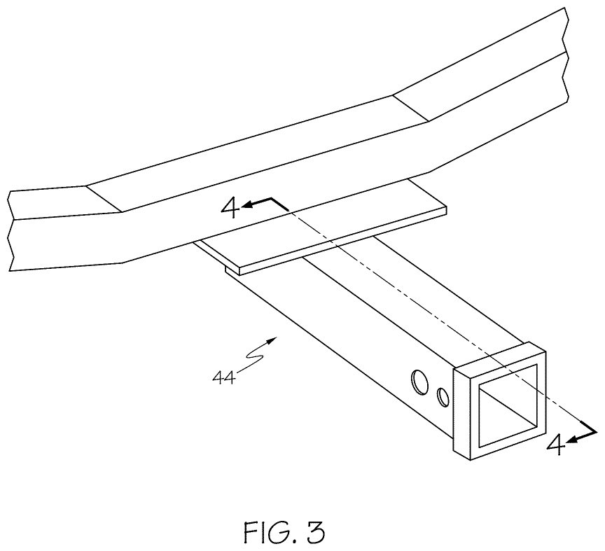

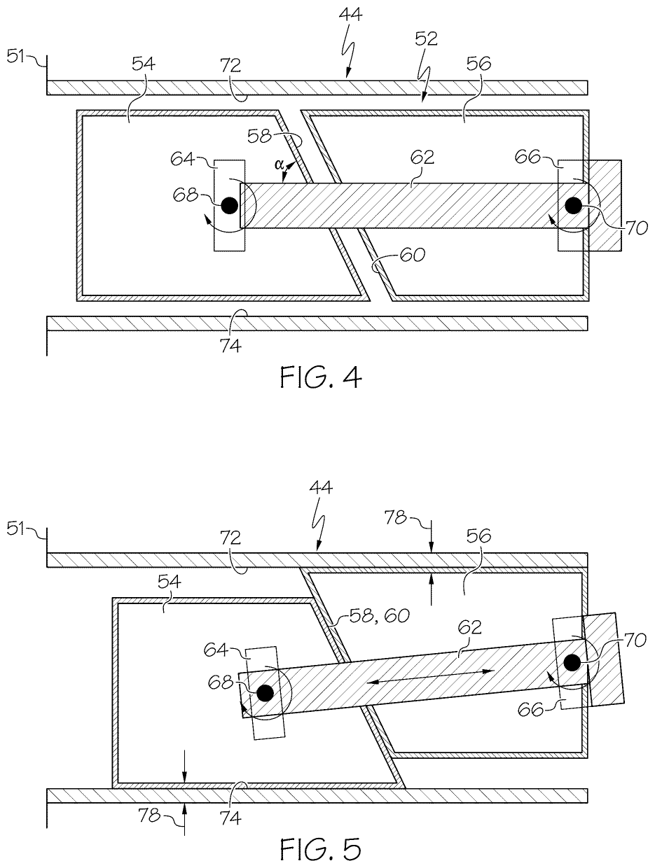

Referring to FIG. 2, a bumper slider 50 can be used to limit damage to the rear bumper 40 due to off-roading. The bumper slider 50 includes a beam-like reinforcement 51 that spans a width of the rear bumper 12 and is sized and shaped to extend underneath the rear bumper 40. Referring briefly to FIG. 3, the trailer hitch tube 44 may be used to mount the bumper slider 50 onto the truck 10. The bumper slider 50 includes a connector assembly 52 mounted on the reinforcement 52 that is sized and shaped to fit within the trailer hitch tube 44 (FIG. 4).

Referring to FIGS. 4 and 5, the connector assembly 52 includes a pair of opposing wedge members 54 and 56 having angled faces 58 and 60 that face each other. The faces 58 and 60 are angled in that they extend oblique relative to a longitudinal axis of the trailer hitch tube 44. For example, the face 58 may extend at an angle α of between about 30 to 60 degrees to the longitudinal axis. A fastener 62 connects the wedge members 54 and 56 together using connectors, such as a nut 64 and a cylinder 66. FIG. 4 illustrates the wedge members 54 and 56 in an initial configuration for insertion into the trailer hitch tube 44. The nut 64 and cylinder 66 are connected to the wedge members 54 and 56 at pivot locations 68 and 70, for example, using pins such that torqueing the fastener 62 pulls the wedge members 54 and 56 together. The nut 64 and cylinder 66 are allowed to pivot, as shown by FIG. 5, causing the wedge members 54 and 56 to slide laterally in opposite directions thereby engaging opposing interior surfaces 72 and 74 of the trailer hitch tube 44 in an engaged configuration. Arrows 78 represent friction forces that are created due to the outward sliding on the wedge members 54 and 56 into the interior surfaces 72 and 74. The threaded connection between the nut 64 and the fastener 62 maintains a level of torque once the torqueing process is completed which holds the bumper slider 50 in place. The bumper slider 50 can be released from the trailer hitch tube 44 by unscrewing the fastener 62 and removing the connector assembly 52 from the trailer hitch tube 44.

The above-described trailer hitch mounted accessories include a connector assembly that includes opposing wedge members that have angled faces that cause the wedge members to offset and slide toward interior walls of a trailer hitch tube. A fastener connects the wedge members and can be torqued to draw the wedge members together to engage the opposing faces. The bumper slider can be made much lighter due to the connector assembly, simple to install and remove. Being able to remove the trailer hitch mounted accessories would make the trailer hitch mounted accessories only effect the vehicle weight while off-road. The trailer hitch mounted accessories may be approximately 10 kg total, compared to 100 kg+ for aftermarket bumpers. This accessory can also be made to meet FMVSS 301 fuel system integrity rear impact. Not requiring a frame attachment for the bumper slider is an advantage because the accessory can retrofit current vehicles with no attachment to the frame. Further, the fastener can be easily accessed through the trailer hitch tube, which allows for easy connection and disengagement of the connector assembly.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A trailer hitch tube mounted vehicle accessory comprising:
a connector assembly comprising a pair of opposing wedge members having angled faces that face each other and a fastener that connects the wedge members together such that torqueing the fastener pulls the wedge members together causing the wedge members to slide laterally in opposite directions thereby engaging opposing interior surfaces of a trailer hitch tube.

2. The trailer hitch tube mounted vehicle accessory of claim 1 further comprising a reinforcement mounted to the connector assembly, the reinforcement configured to extend along a width of a rear bumper of a vehicle.

3. The trailer hitch tube mounted vehicle accessory of claim 2, wherein the reinforcement is located underneath the rear bumper.

4. The trailer hitch tube mounted vehicle accessory of claim 1 further comprising a cylinder connected to a first wedge member of the pair of opposing wedge members and a nut connected to a second wedge member of the pair of opposing wedge members, wherein the fastener extends through the cylinder and is threaded through the nut.

5. The trailer hitch tube mounted vehicle accessory of claim 4, wherein the nut is pivotally connected to the first wedge member and the cylinder is pivotally connected to the second wedge member.

6. A vehicle comprising:
a trailer hitch tube; and
a trailer hitch tube mounted vehicle accessory comprising a connector assembly mounted within the trailer hitch tube, the connector assembly comprising a pair of opposing wedge members having angled faces that face each other and a fastener that connects the wedge members together such that torqueing the fastener pulls the wedge members together causing the wedge members to slide laterally in opposite directions thereby engaging opposing interior surfaces of the trailer hitch tube.

7. The vehicle of claim 6, wherein the trailer hitch tube mounted vehicle accessory further comprises a reinforcement mounted to the connector assembly, the reinforcement configured to extend along a width of a rear bumper of the vehicle.

8. The vehicle of claim 2, wherein the reinforcement is located underneath the rear bumper.

9. The vehicle of claim 6 further comprising a cylinder connected to a first wedge member of the pair of opposing wedge members and a nut connected to a second wedge member of the pair of opposing wedge members, wherein the fastener extends through the cylinder and is threaded through the nut.

10. The vehicle of claim 9, wherein the nut is pivotally connected to the first wedge member and the cylinder is pivotally connected to the second wedge member.
